(19) United States
(12) Patent Application Publication
(10) Pub. No.: US 2012/0033142 A1
(43) Pub. Date: Feb. 9, 2012

(54) User-Wearable Video Displays, Systems and Methods

(76) Inventor: Chip E. Thomson, Austin, TX (US)

(21) Appl. No.: 13/146,619

(22) PCT Filed: Jan. 27, 2010
(86) PCT No.: PCT/US10/22270

§ 371 Date: Oct. 19, 2011

Related U.S. Application Data
(60) Provisional application No. 61/147,682, filed on Jan. 27, 2009.
(60) Provisional application No. 61/166,832, filed on Apr. 6, 2009.
(60) Provisional application No. 61/170,882, filed on Apr. 20, 2009.

(51) Int. Cl. H04N 5/64

(52) U.S. Cl. 348/838; 348/E05.128

(57) ABSTRACT

User-wearable video display devices, systems and methods

### RELATED APPLICATIONS

This application claims the priority of: U.S. Provisional Patent Application Ser. No. 61/147, 682, filed Jan. 27, 2009; U.S. Provisional Patent Application Ser. No. 61/166,832, filed Apr. 6, 2009; and U.S. Provisional Patent Application Ser. No. 61/170,882, filed Apr. 20, 2009; the entire disclosures of which are specifically incorporated herein by reference.

### BACKGROUND OF THE INVENTION

1. Field of the Invention

The present invention relates generally to video display devices, and, more particularly, but not by way of limitation, to user-wearable video display devices, systems, and methods of use.

2. Description of Related Art

A number of user-wearable video display devices and systems have been developed and/or are in use in the art.

The following references may disclose examples of user-wearable video display devices, and may facilitate a more complete understanding of the various embodiments of the present invention and uses for the various embodiments of the present invention: (1) U.S. patent application Ser. No. 09/225,574, filed Jan. 5, 1999, and published as Pub. No. US 2003/0044757; (2) U.S. Pat. No. 7,249,846, filed May 3, 2006; (3) U.S. Pat. No. 7,217,164, filed Jun. 1, 2006; (4) U.S. Pat. No. 7,185,983, filed Apr. 13, 2004; (5) U.S. Pat. No. 6,981,876, filed Jun. 7, 2004; (6) U.S. Pat. No. 6,881,067, filed Jun. 11, 2002; (7) U.S. Pat. No. 6,045,224, filed Apr. 29, 1997; (8) U.S. Pat. No. 5,984,684, filed Dec. 2, 1996; (9) U.S. Pat. No. 5,924,868, filed Sep. 18, 1996; (10) U.S. Pat. No. 5,823,786, filed Aug. 15, 1997; and (11) U.S. Pat. No. 5,249,967, filed Jul. 12, 1991. The foregoing references numbered (1) through (11) are incorporated by reference in their entireties.

### SUMMARY OF THE INVENTION

The present disclosure includes various embodiments of user-wearable video displays, systems, and methods.

Some embodiments of the present user-wearable video display devices comprise: a lateral member; a frame pivotally coupled to the lateral member; and a video screen (e.g., two video screens) coupled to the frame and capable of displaying video images; where the device is configured to be wearable by a user such that, if the device is worn by a user, the video screen is in front of the user's face, and the lateral member extends across a portion of the user's face.

In some embodiments, the device is further configured to be wearable by a user such that, if the device is worn by a user, the lateral member contacts a portion of the user's face. In some embodiments, the lateral member comprises a non-rigid material. In some embodiments, the non-rigid material is compressible. In some embodiments, the non-rigid material is resilient. In some embodiments, the device is configured such that the frame is capable of pivoting relative to the lateral member about a lateral horizontal axis extending through the lateral member.

In some embodiments, the device further comprises: two arms coupled to the lateral member such that the frame is capable of pivoting relative to the lateral member and both arms about a lateral horizontal axis extending through at least one of the lateral member and both arms; where the device is further configured to be wearable by a user such that, if the device is worn by a user, each of the two arms extends over a different one of the user's ears. In some embodiments, the two arms are integral to the lateral member.

In some embodiments, the device further comprises: a support member coupled to the lateral member, the support member having a bridge end; where device is further configured to be wearable by a user such that, if the device is worn by a user, the bridge end of the support member rests on the user's nose. In some embodiments, the support member is removably coupled to the lateral member. In some embodiments, the support member is disposed at about the middle of the lateral member. In some embodiments, the support member is coupled to the lateral member such that the position of the bridge end relative to the lateral member is adjustable.

In some embodiments, the device the device is further configured to be wearable by a user such that, if the device is worn by a user, at least a portion of the lateral member extends above at least a portion of a users eyes. In some embodiments, the device is further configured to be wearable by a user such that, if the device is worn by a user, the support member extends downward from the lateral member such the bridge end is disposed below at least a portion of the lateral member. In some embodiments, the support member is integral to the lateral member.

In some embodiments, the frame is pivotally coupled to the lateral member such that at least one characteristic of the pivotal relationship between the frame and lateral member is adjustable. In some embodiments, the frame is pivotally coupled to the lateral member by tension screws such that the force required to pivot the frame relative to the lateral member can be adjusted by rotating one or more of the tension screws.

Some embodiments of the present user-wearable video display devices comprise: a lateral member; two arms coupled to the lateral member; a frame pivotally coupled to the lateral member; and a video screen coupled to the frame and capable of displaying video images; where the device is configured to be wearable by a user such that, if the device is worn by a user, the video screen is in front of the user's face and each of the two arms extends over a different one of the user's ears.

Some embodiments of the present user-wearable video display devices comprise: a lateral member; a user-attachment band structure coupled to the lateral member; a frame pivotally coupled to the lateral member; and a video screen coupled to the frame and capable of displaying video images; where the device is configured to be wearable by a user such that, if the device is worn by a user, the video screen is in front of the user's face, and the user-attachment band structure wraps around a portion of the user's head.

In some embodiments, the user-attachment band structure is coupled to the lateral member such that the lateral horizontal axis also extends through a portion of the user-attachment band structure, and the frame is also capable of pivoting relative to the band structure. In some embodiments, the user-attachment band structure comprises: first and second band clips; and an elongated band coupled to and extending between the first and second band clips; where one of the two arms is coupled to a left side of the lateral member, the other of the two arms is coupled to a right side of the lateral member, the first band clip is configured to be capable of being coupled to the left arm, and the second band clip is configured to be capable of being coupled to the right arm. In some embodiments, the first and second band clips are removably coupled to the left and right arms, respectively. In some embodiments, the first and second band clips are coupled to the left and right arms, respectively, in non-pivoting relation. In some embodiments, the elongated band is elastic.

Some embodiments of the device further comprise two arms coupled to the lateral member such that the frame is capable of pivoting relative to the lateral member and both arms about a lateral horizontal axis extending through at least one of the lateral member and both arms; where the device is further configured to be wearable by a user such that, if the device is worn by a user, each of the two arms extends over a different one of the user's ears. Some embodiments further comprise: a support member coupled to the lateral member, the support member having a bridge end; where device is further configured to be wearable by a user such that, if the device is worn by a user, the bridge end of the support member rests on the user's nose. In some embodiments, the support member is coupled to the lateral member such that the position of the bridge end relative to the lateral member is adjustable.

Some embodiments of the present user-wearable video display devices comprise: a lateral member; a frame pivotally coupled to the lateral member; and a hat bill-attachment structure coupled to the frame; a video screen coupled to the frame and capable of displaying video images; where the device is configured to be wearable by a user such that, if the device is worn by a user, the video screen is in front of the user's face, and the lateral member extends across a portion of the user's face. In some embodiments, the video screen coupled to the frame and capable of displaying video images comprises two video screens coupled to the frame, each of which is capable of displaying video images. In some embodiments, the video screen is coupled to the frame through a housing member that is pivotally coupled to the frame and that can pivot relative to the frame. In some embodiments, the device is further configured to be wearable by a user such that, if the device is worn by a user, the lateral member contacts a portion of the user's face. In some embodiments, the lateral member comprises a non-rigid material. In some embodiments, the non-rigid material is compressible. In some embodiments, the non-rigid material is resilient. In some embodiments, the device is configured such that the frame is capable of pivoting relative to the lateral member about a lateral horizontal axis extending through the lateral member.

In some embodiments, the device further comprises: a user-attachment band structure coupled to the lateral member. In some embodiments, the user-attachment band structure is coupled to the lateral member such that the lateral horizontal axis also extends through a portion of the user-attachment band structure, and the frame is also capable of pivoting relative to the band structure. In some embodiments, the user-attachment band structure comprises: first and second band clips; and an elongated band coupled to and extending between the first and second band clips; where the first band clip is configured to be capable of being coupled to the left side of the lateral member, and the second band clip is configured to be capable of being coupled to the right side of the lateral member. In some embodiments, the first and second band clips are removably coupled to the left and right sides of the lateral member, respectively. In some embodiments, the first and second band clips are coupled to the left and right sides of the lateral member, respectively, in non-pivoting relation. In some embodiments, the elongated band is elastic.

In some embodiments, the hat bill-attachment structure includes an elastic band. In some embodiments, the hat bill-attachment structure comprises an adjustable lateral portion configured to be coupled to the bill of a hat. In some embodiments, the hat bill-attachment structure is oriented in a first plane, the user-attachment band structure is oriented in a second plane, and the first and second planes are oriented at an angle of between 5 and 45 degrees to each other. In other embodiments, the first and second planes are oriented at an angle of between 10 and 30 degrees to each other, between 15 and 25 degrees to each other, or at any other degree between 0 and 90 degrees.

In some embodiments, the display device further comprises: a support member coupled to the lateral member, the support member having a bridge end; where the device is further configured to be wearable by a user such that, if the device is worn by a user, the bridge end of the support member rests on the user's nose. In some embodiments, the support member is removably coupled to the lateral member. In some embodiments, the support member is disposed at about the middle of the lateral member. In some embodiments, the support member is coupled to the lateral member such that the position of the bridge end relative to the lateral member is adjustable. In some embodiments, the device is further configured to be wearable by a user such that, if the device is worn by a user, at least a portion of the lateral member extends above at least a portion of a users eyes. In some embodiments, the device is further configured to be wearable by a user such that, if the device is worn by a user, the support member extends downward from the lateral member such the bridge end is disposed below at least a portion of the lateral member. In some embodiments, the support member is integral to the lateral member.

In some embodiments, the frame is pivotally coupled to the lateral member such that at least one characteristic of the pivotal relationship between the frame and lateral member is adjustable. In some embodiments, the frame is pivotally coupled to the lateral member by tension screws such that the force required to pivot the frame relative to the lateral member can be adjusted by rotating one or more of the tension screws.

Some embodiments of the present kits comprise a user-wearable video display device where the frame is pivotally coupled to the lateral member such that at least one characteristic of the pivotal relationship between the frame and lateral member is adjustable; and a tool configured to adjust the at least one characteristic of the pivotal relationship between the frame and lateral member is adjustable. In some embodiments, the frame is pivotally coupled to the lateral member by tension screws such that the force required to pivot the frame relative to the lateral member can be adjusted by rotating one or more of the tension screws. In some embodiments, the tool comprises a screwdriver.

Some embodiments of the present kits comprise a user-wearable video display device and a case configured enclose the user-wearable video display device. In some embodiments, the arms of the device are non-collapsible relative to the lateral member.

Some embodiments of the present systems comprise: a user-wearable video display device; an emitter configured to be capable of wirelessly transmitting video data including video images; and a receiver configured to be capable, if video data is wirelessly transmitted from the emitter, of receiving wirelessly the video data from the emitter and communicating the video data to the user-wearable video display device. Some embodiments further comprising a cable connecting the receiver and the user-wearable video display device such that the receiver can communicate the video data to the user-wearable video display device via the cable. In some embodiments, the emitter is further configured to be capable of receiving video data from a video source. In some embodiments, the video source is a video camera. In some embodiments, the video source is a personal media device.

In some embodiments, the receiver comprises a cable having a connector, the user-wearable video display device comprises a cable having a connector, and the connector of the receiver is configured to be coupled to the connector of the user-wearable video display device such that video data can be communicated from the receiver to the to the user-wearable video display device via the cable of the receiver and the cable of the user-wearable video display device. In some embodiments, the receiver comprises a cable retractor having an actuator, and the cable retractor is configured to retract the cable responsive to the actuator being actuated by a user. In some embodiments, the receiver is coupled to the user-wearable video display device.

In any of these embodiments, the video screen may comprise two video screens, each of which is coupled to the frame and capable of displaying video images. In any of these embodiments, the video screen can be coupled to the frame through a housing member that is pivotally coupled to the frame and that can pivot relative to the frame.

Any embodiment of any of the present methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. FIGS. 2A, 2B, 3A, 3B, 3C, 3D, 3E, 4A, 4B, 5A, 5B, 6A, 6B, 7A, 7B, 8A, and 8B are drawn to scale, meaning the sizes of the depicted elements are accurate relative to each other for at least one set of embodiments of the present devices and systems.

FIG. 1 depicts one of the present systems that includes a user-wearable video display device.

FIGS. 2A-2B depict perspective and side views, respectively, of one embodiment of the present user-wearable video display devices in a non-rotated position.

FIGS. 3A-3E depict various enlarged and exploded views of portions of the user-wearable video display device of FIGS. 2A-2B.

FIGS. 4A-4B depict partially disassembled left and right side views of the user-wearable video display device of FIGS. 2A-2B.

FIGS. 5A-5B depict front and side views, respectively, of the user-wearable video display device of FIGS. 2A-2B in a pivoted configuration.

FIGS. 6A-6B depict front and side views, respectively, of the user-wearable video display device of FIGS. 2A-2B in another pivoted configuration.

FIGS. 7A-7B depict side and front views, respectively, of an emitter suitable for use with the system of FIG. 1.

FIGS. 8A-8B depict side and front views, respectively, of a receiver suitable for use with the system of FIG. 1.

FIG. 9A-9B depict various partially disassembled views of the receiver of FIGS. 8A-8B.

FIG. 10 depicts a schematic of a transmitter module suitable for use with one of the present emitters.

FIG. 11 depicts a schematic of a receiver module suitable for use with one of the present receivers.

FIGS. 12A-12B depict perspective views of another embodiment of a user-wearable video-display device suitable for use with the system of FIG. 1 and worn by a user.

FIG. 13 depicts an upper perspective view of the embodiment of FIGS. 12A-12B worn by a user.

FIGS. 14A-14B depict side views of the embodiment of FIGS. 12A-12B worn by a user.

FIG. 15 depicts a perspective view of the embodiment of FIGS. 12A-12B.

FIG. 16 depicts an exploded view of the embodiment of FIGS. 12A-12B.

FIGS. 17A-17B depicts partially disassembled side views of the embodiment of FIGS. 12A-12B.

FIG. 18 depicts a perspective view of a lateral portion of a hat bill-attachment structure of some embodiments of the present user-wearable video-display devices.

FIG. 19 depicts various views of an adjustment assembly for use with the user-wearable video display devices of the present disclosure.

### DESCRIPTION OF ILLUSTRATIVE EMBODIMENTS

The term “coupled” is defined as connected, although not necessarily directly, and not necessarily mechanically; two items that are “coupled” may be integral with each other. Items may also be “non-integrally coupled.” The terms “a” and “an” are defined as one or more unless this disclosure explicitly requires otherwise. The terms “substantially,” “approximately,” and “about” are defined as largely but not necessarily wholly what is specified, as understood by a person of ordinary skill in the art.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a device, system or method that “comprises,” “has,” “includes” or “contains” one or more elements or steps possesses those one or more elements or steps, but is not limited to possessing only those elements or steps. For example, a user-wearable video display device that comprises a video screen and a frame, includes the specified elements but is not limited to having only those elements. For example, such a device could also include a second video screen, a pair of arms, and/or a user-attachment band structure.

Further, a device or structure that is configured in a certain way is configured in at least that way, but it can also be configured in ways other than those specifically described.

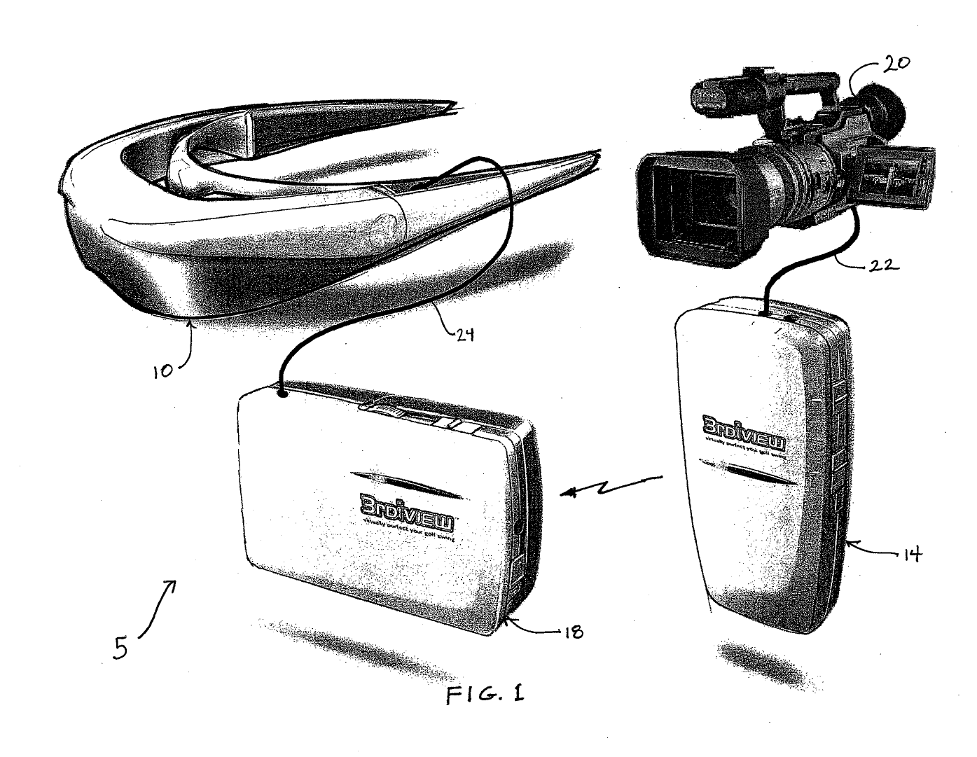

Referring now to the drawings, and more particularly to FIG. 1, shown there and designated by the reference numeral 5 is one of the present systems that comprises a user-wearable video display device 10. The user-wearable video display device 10 may be interchangeably referred to here as device 10, video device 10, or video display device 10. In the embodiment shown, system 5 also comprises: an emitter 14; a receiver 18; a video source 20; a source cable 22; and a display cable 24. Emitter 14 is configured to be capable of wirelessly transmitting video data including, but not necessarily limited to, video images. For example, in some embodiments, the emitter is configured to be capable of wirelessly transmitting video data including only video images; and in other embodiments, the emitter is configured to be capable of wirelessly transmitting video data including video images and audio sounds. Receiver 18 is configured to be capable, if video data is wirelessly transmitted from the emitter, of receiving wirelessly the video data (including audio sounds) from the emitter and communicating the video data to display 10 (e.g., via display cable 24).

Video source 20 is configured to be capable of storing or generating video data in a format that the video data can be communicated to, or accessed by, the emitter; the video source, therefore, is also configured to be capable of transmitting video data. For example, the video source can be a personal media player having memory for storing video data, e.g., an Apple iPod®, or a Microsoft ZUNE. By way of other examples, the video source can a digital video camera configured to capture (e.g., live video capture (but not store on a medium such as a tape)) and/or record video data; or a portable hard drive. In the embodiment shown, the video source is coupled to the emitter by way of source cable 22, and the source cable is a patch cable having 2.5 mm (ear phone) plugs (for connecting to the video source and emitter). In other embodiments, the source cable can be any suitable cable for communicating video data, and can include one or more wires or discrete communication paths. For example, the source cable can include any one or more of: an RCA audio or video cable, an HDMI cable, a USB cable, a fiber optic cable, or the like. In some embodiments, the video source and the emitter can be a single unit, such as, for example, a cellular phone configured to be capable of: storing or generating video data, and transmitting wirelessly video data to the receiver, e.g., via Bluetooth, wifi, infrared link, or the like. Display cable 24 can similarly be any suitable cable configured to be capable of communicating video data (including audio sounds) from the receiver 18 to display 10. In embodiments in which a display cable 24 is used, the display cable may include a power source for the device 10 if the same is not provided in the receiver; the display cable may include an on/off switch that, when toggled to “on,” allows video data (including images and sound) to reach the device; and may include a volume controller for the sound data that is transmitted to the device. The functions the display cable performs can integrated into receiver 18 in other embodiments.

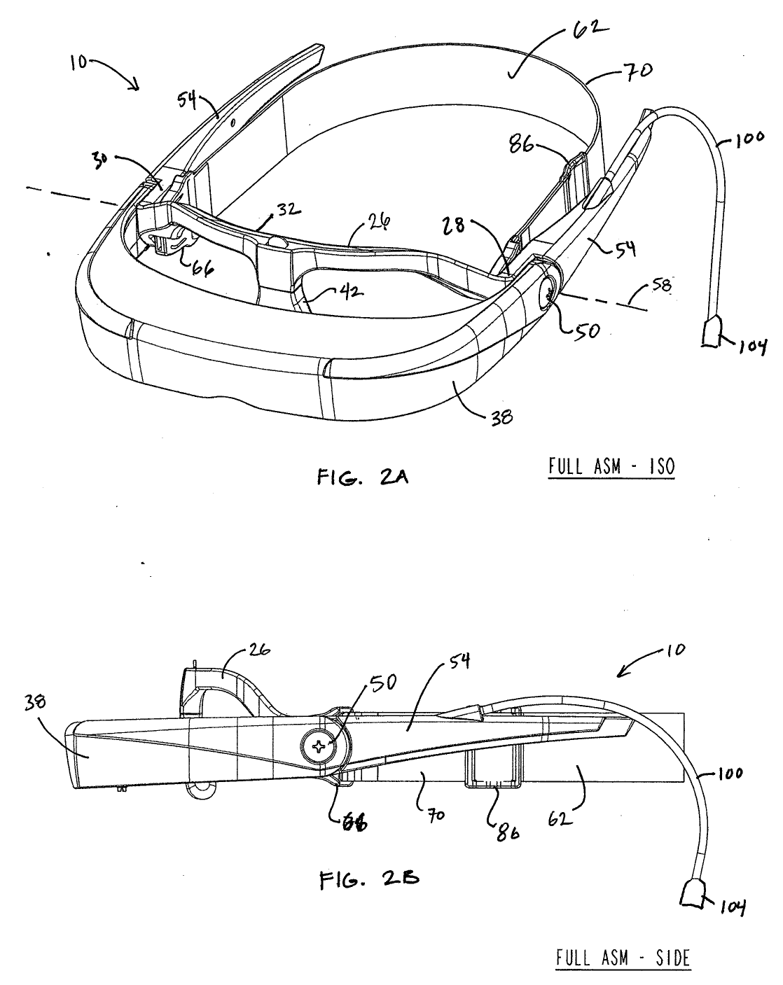

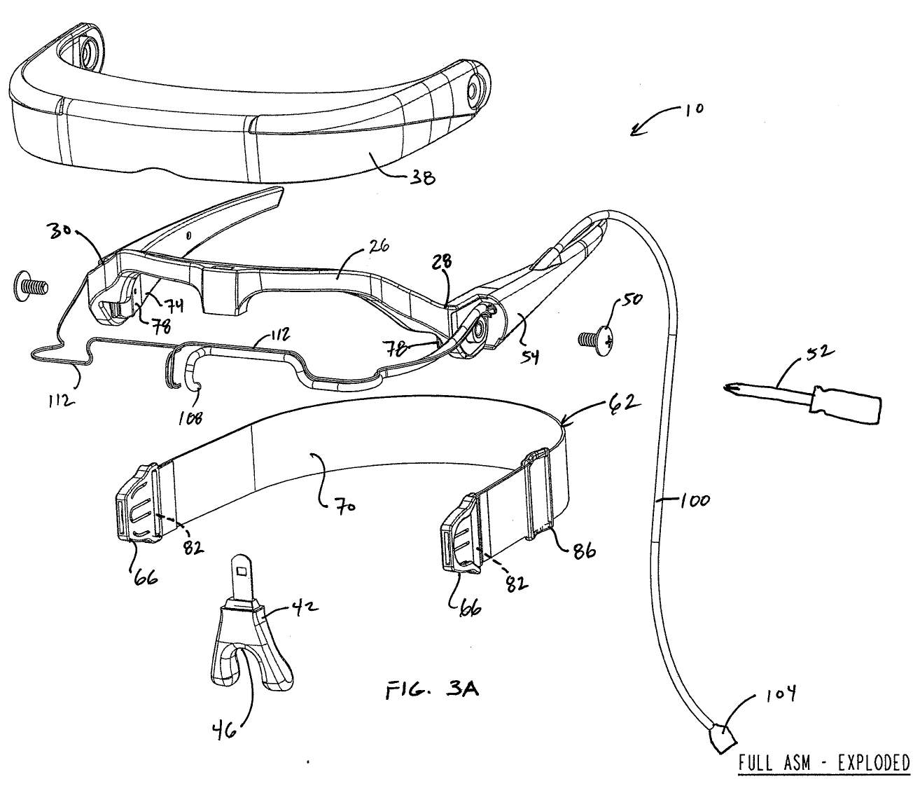

Referring now to FIGS. 2A-2B, 5A-5B, and 6A-6B, various views are shown of a user-wearable video display device 10 that is suitable for use with system 5. As will be appreciated when viewing the figures, the display can be worn similarly to the way a pair of glasses is worn. Terms such as “vertical” and “horizontal” are used to describe various features of the display when worn in a non-rotated and non-extended position (as will be described in more detail below) by a human user who is sitting or standing such that the user's head is substantially upright. These terms do not limit the orientation of the features, as the orientation of such “vertical” and “horizontal” features will necessarily vary when the display is not worn by a user, or when the display is worn by a user and the user is in other positions.

In the embodiment shown, the display device comprises: a lateral member 26, video screen 34 (which may, for example, be a stereoscopic video display), a frame 38, and a support member 42. The embodiment of device shown is configured to be wearable by a user such that, if the device is worn by a user, the video screen is in front of the user's face, and the lateral member extends across a portion of the user's face and/or contacts a portion of the user's face (e.g., the user's forehead). In the embodiment shown, the device is further configured to be wearable by a user such that, if worn by a user, at least a portion of the lateral member extends above at least a portion of a users eyes. As shown, lateral member 26 comprises a first end 28, and a second end 30. The lateral member contours upwards at its lateral middle (or lateral center), as shown, such that lateral member 26 does not obstruct at least a portion of a user's field of view if the device is worn by a user. Lateral member 26 can comprise any suitable material, such as, for example, plastic, composite, polymer, aluminum, or the like. In some embodiments, lateral member comprises a non-rigid material 32 on an inner surface (a surface that is adjacent to a user's face (e.g., forehead) if the device is worn by a user). Non-rigid material 32 can be compressible and/or resilient, and can comprise any suitable material, such as, for example, foam, rubber, fabric, or the like.

Video screen 34 is configured to be capable of displaying video images. In the embodiment shown, video screen 34 comprises two video screens. In other embodiments, the video screen can be only a single video screen, such as, for example, having two windows or in any other suitable configuration, including one that includes a magnifying lens (or lenses) in front of the screen. The video screen can be any structure or assembly capable of displaying video images, such as, for example, a liquid crystal display (LCD), or the like. It may also be configured to display video images in stereoscopic fashion. The video screen may include or be part of a video engine, or a video engine (not shown) may be separately included in the device. For example, suitable video engines are available from Ester Electronic & Technology Co., Ltd., Shenzken, Guangdong, China. As shown, frame 38 is coupled to the video screen such that the frame supports, directly or indirectly, the video screen.

Support member 42 is coupled to the lateral member, and support member 42 has a bridge end 46 configured to be capable of resting on the bridge of a user's nose if the display is worn by a user. In this way, the device is configured to be wearable by a user such that, if the device is worn by a user, the video screen is in front of the user's face and the bridge end of the support member rests on the user's nose. More specifically, as shown, the support member is disposed at about the middle of the lateral member such that the support member extends downward from the lateral member such that bridge end 46 is disposed below at least a portion of the lateral member (e.g., the middle portion of the lateral member from which the support member extends from). In the embodiment shown, the support member is removably coupled to lateral member (e.g., is configured to be removable, and can be removed, from the lateral member without damaging the lateral member). In other embodiments, the support member is integral to the lateral member (e.g., is not removable, and/or is of unitary construction).

Frame 38 is pivotally coupled to lateral member 42 such that frame 38 is capable of pivoting relative to lateral member 26. More specifically, in the embodiment shown, the frame is pivotally coupled to the lateral member such that at least one characteristic of the pivotal relationship between the frame and lateral member is adjustable. Characteristics of such pivotal relationship that can be adjustable include, for example, one or more of resistant to pivotal motion (the force required to pivot the frame relative to the lateral member), range of pivotal motion, and the like. For example, the frame can be coupled to the lateral member by tension screws 50 such that the force required to pivot the frame relative to the lateral member can be adjusted by rotating (e.g., by way of a tool 52 such as, for example, a screwdriver or the like) one or more of tension screws 50. In some embodiments, a kit comprises system 5 (or at least device 10) and tool 52. In some embodiments, a kit comprises system 5 (or at least device 10) and a case (not shown, but individually known in the art in other configurations) configured to enclose the user-wearable video display device. In other embodiments, the frame can be pivotally coupled to the lateral member by any suitable means, such as, for example, rivets, pins and tabs/slots, or the like. As a result of configuring device 10 in this manner, the device (and, more specifically frame 38) has a non-pivoted position (e.g., FIG. 2B) and any one of multiple pivoted positions (e.g., FIGS. 5A-6B) that allow a wearer of the device, who desires to use it as a training aide to view real-time video images of a sports movement (or the like) the wearer performs, to adjust the pivoted or non-pivoted position (or angle) of the frame (and of the video screen 34), relative to the lateral member, to best suit the sports movement the wearer wishes to perform.

In the embodiment shown, display 10 also comprises two arms 54 coupled to lateral member 26 such that the frame is also capable of pivoting or rotating (or configured to pivot or rotate) relative to both arms about a lateral horizontal axis 58 extending through both arms (and/or through the lateral member, such as, for example, through both ends 28 and 30 of the lateral member). More specifically, in the embodiment shown, the arms are integral to the lateral member (are of unitary or one-piece construction). In other embodiments, the arms can be separately formed and can be coupled (e.g., non-pivotally) to the lateral member by any suitable means, such as, for example, by one or more of screws, rivets, tabs and slots, welding (e.g., plastic welding), adhesive, and the like. In embodiments, such as the one shown, in which the arms are fixed (non-collapsible) relative to the lateral member, the device can be described as having a non-collapsible configuration and/or as having two arms that are non-collapsible relative to the lateral member.

In the embodiment shown, device 10 comprises a user-attachment band structure 62 coupled to at least one of the lateral member and the arms (and/or both, directly or indirectly). User-attachment band structure 62 may be interchangeably referred to as band structure 62. In some embodiments, device 10 is configured to be wearable by a user such that, if the device is worn by a user, each of the two arms extends over a different one of the user's ears and the user-attachment band structure wraps around a portion of the user's head.

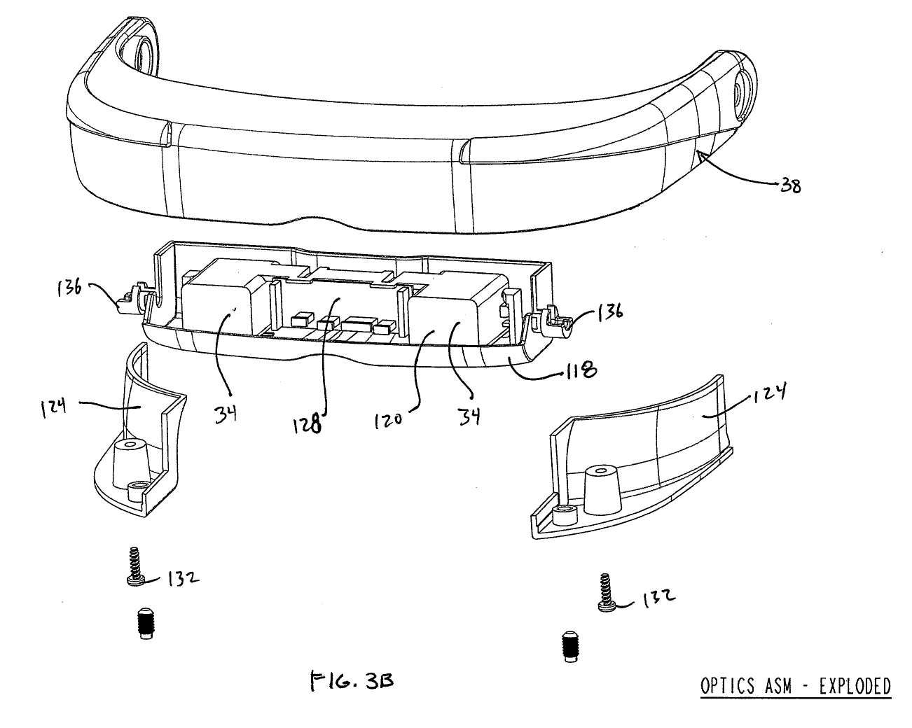

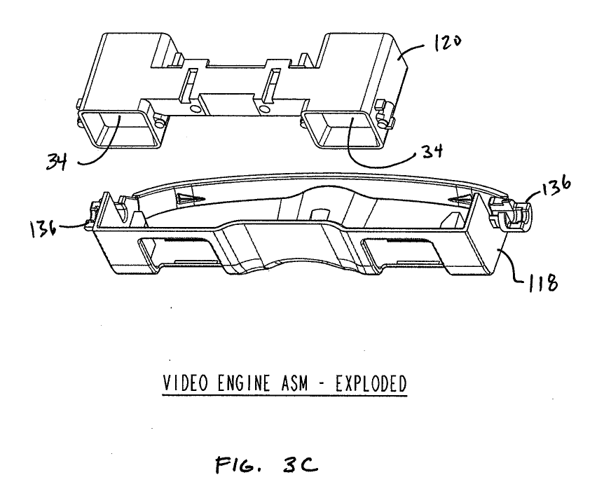

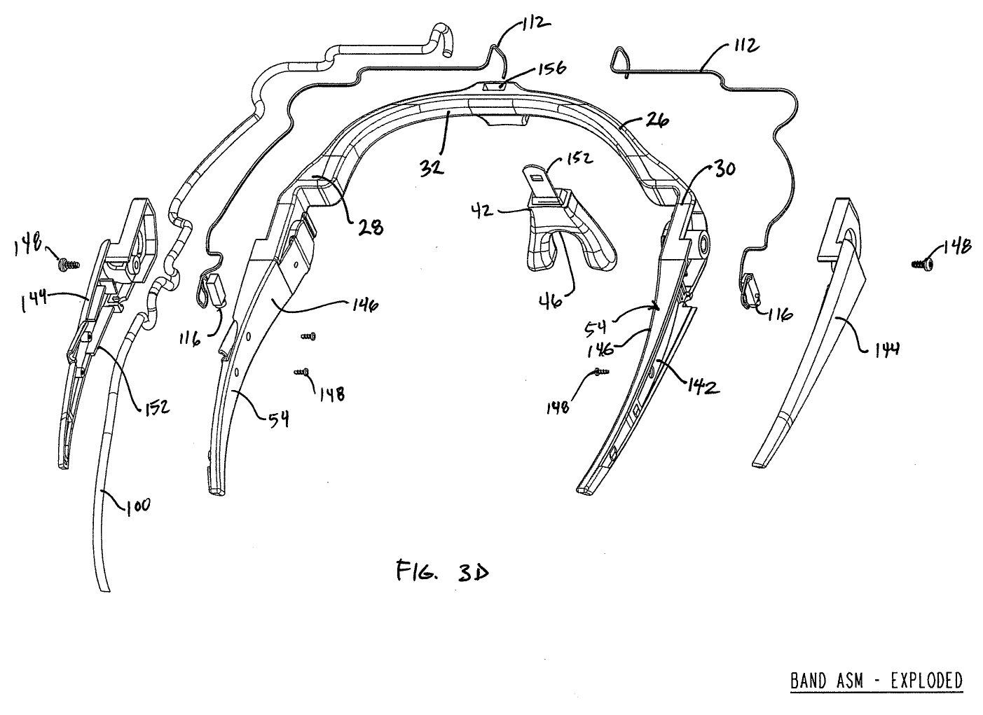

More specifically, in the embodiment shown, band structure 62 comprises first and second band clips 66 and an elongated band 70 coupled to and extending between first and second band clips 66. As described above, one of the two arms is coupled to a left side of the lateral member, and the other of the two arms is coupled to a right side of the lateral member, the first band clip is configured to be capable of being coupled to the left arm, and the second band clip is configured to be capable of being coupled to the right arm. As best shown in FIG. 3A, a forward portion 74 of each arm (and/or each end of the lateral portion) can be provided with a tab 78, and each band clip 66 can be provided with a shape corresponding to forward portion 74 and tab 78 such that the band clip can be snapped or clipped (e.g., removably) over the forward portion 74 and/or tab 78. In this way, each band clip is capable of being coupled to a respective arm in a substantially fixed (e.g., non-pivoting) relationship to that arm, such that the frame can be pivoted or rotated relative to both arms and the band structure. In some embodiments, band 70 and/or band structure 62 can comprise a ratcheting adjustment mechanism, such as may be used on certain hardhats, helmets, and the like.

Each clip can also comprise a slot 82 configured to receive a portion of the band 70. In some embodiments, the band is elastic. The band can comprise any suitable material, such as, for example, a fabric strap, an elastic strap, a leather strap, a plastic strap, or the like. In some embodiments, device 10 also comprises an adjuster 86 to permit a user to adjust the length of the band extending between the band clips.

In the embodiment shown, the band structure is coupled to the lateral member such that the lateral horizontal axis also extends through a portion of the user-attachment band structure and the frame is also capable of pivoting relative to the band structure as well as the lateral member and both arms. In the embodiment shown, the band structure is configured such that support member 42 can be removed (e.g., during an active sport or the like) and the band structure and arms can cooperate to hold the device in position if worn by a user such that the band structure wraps around the user's head and each of the arms extends over a different one of the user's ears.

Device 10 (and more specifically frame 38) can be described as having at least (1) a non-rotated position (or configuration or orientation), (2) an upwardly rotated position (or configuration or orientation); and (3) a downwardly rotated position (or configuration or orientation). In the non-rotated position, e.g., FIGS. 2A-2B, the arms are substantially aligned with the frame such that, if the device is worn by a user, the video screen is in front of the user's eyes and the bridge end of the support member (if not removed, i.e., coupled to the lateral member) rests on the user's nose (e.g., the bridge of the user's nose). In an upwardly rotated position, e.g., FIGS. 5A-5B, the frame (and video screen) is rotated upward relative to the lateral member (and the arms), such that if worn by a user with the bridge end of the support member (if not removed, i.e., coupled to the lateral member) resting on the user's nose (e.g., the bridge of the user's nose), the frame (and video screen) is raised relative to the user's eyes and oriented such that the user can view the video screen by looking upward; in addition, at least a portion of the user's direct field of vision is unobstructed by the frame and video screen. In a downwardly rotated position, e.g., FIGS. 6A-6B, the frame (and video screen) is rotated downward relative to the lateral member (and the arms), such that if worn by a user with the bridge end of the support member (if not removed, i.e., coupled to the lateral member) resting on the user's nose (e.g., the bridge of the user's nose), the frame (and video screen) is lowered relative to the user's eyes and oriented such that the user can view the video screen by looking downward; in addition, at least a portion of the user's direct field of vision is unobstructed by the frame and video screen. The device is configured to be capable of many different positions in which the frame has been rotated relative to the lateral member, and such positions can be selected for or matched to a given activity that is being performed by a wearer. For example, when a wearer is using the device to improve her tennis serve, she will be viewing video images of herself in real time as she is practicing her serve. Therefore, she may wish to extend the frame so that she can see the ball at the top of her serve and she will have the ability to correspondingly rotate the frame to enable her to view the video screen. In addition, a user may also be able to practice, e.g., a sports movement when the device has not been rotated. For example, in golf, it may be possible to practice a golf swing while viewing real-time video images of that swing when the frame is in a non-rotated position because the wearer will be looking downward. It should be understood that in the non-rotated position, the user's direct field of vision may not necessarily be completely taken up by the video screen and frame due to their size; and in a rotated and extended position, the user's direct field of vision may not necessarily be completely unobstructed.

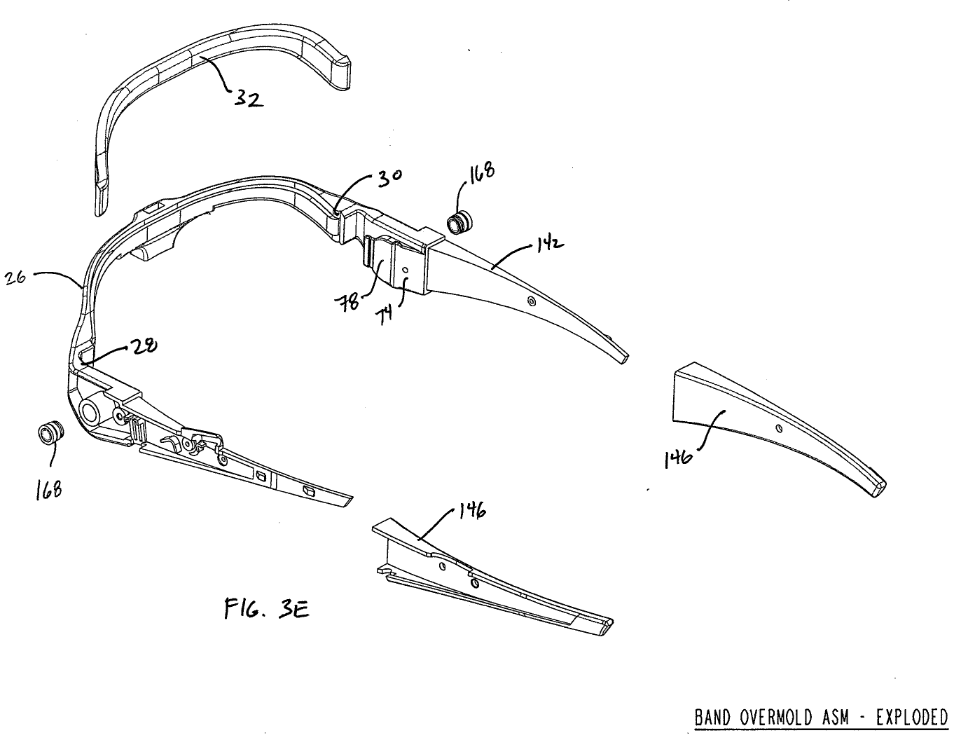

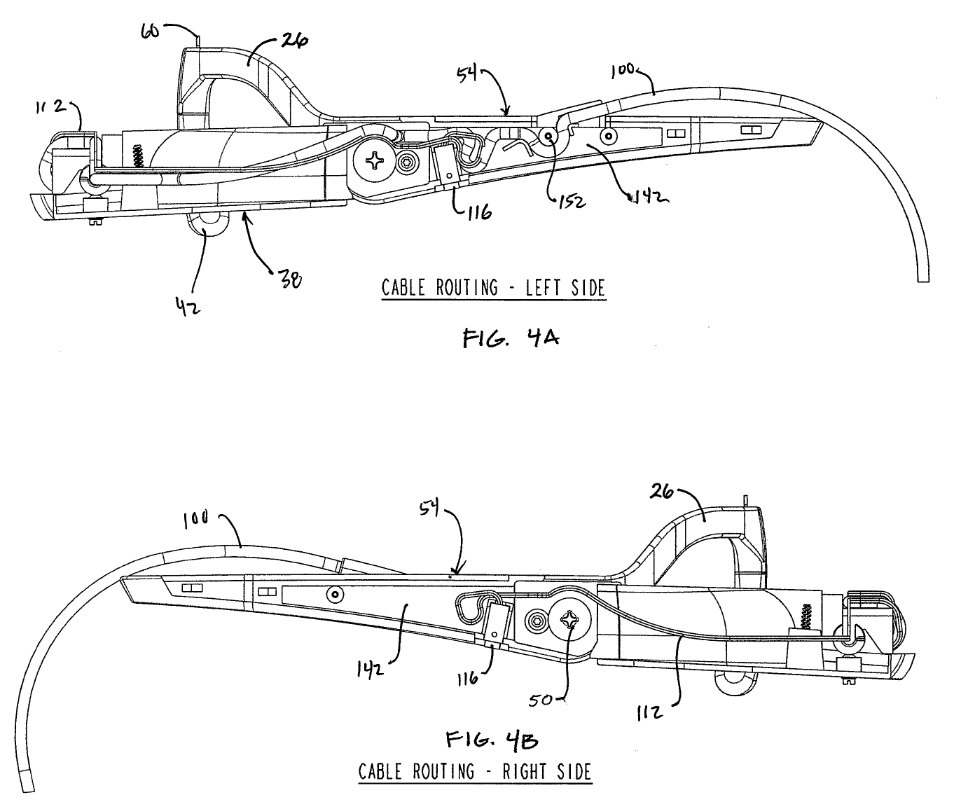

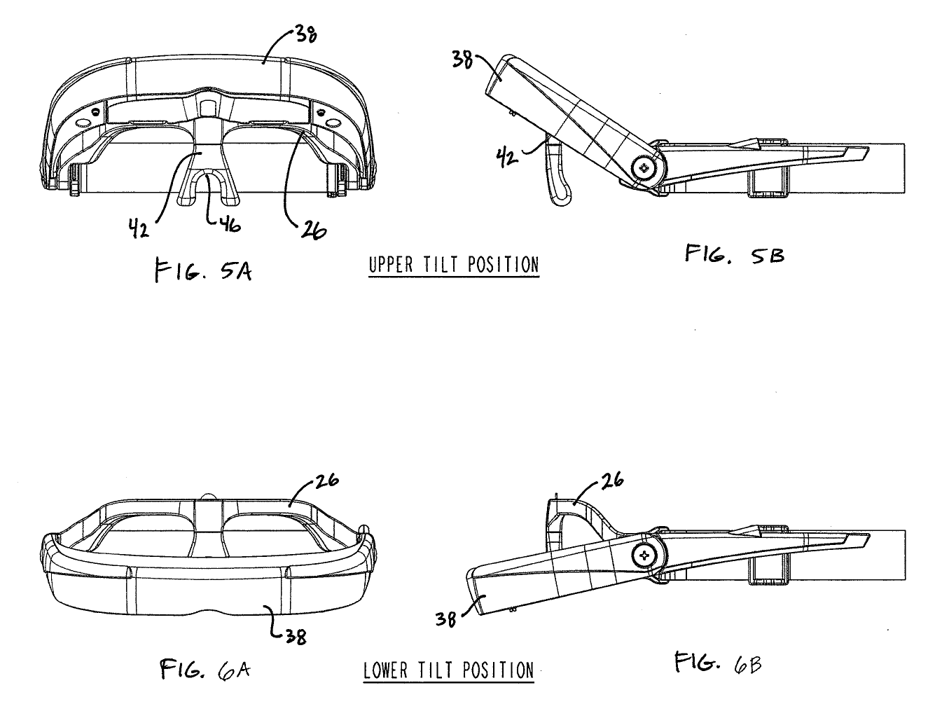

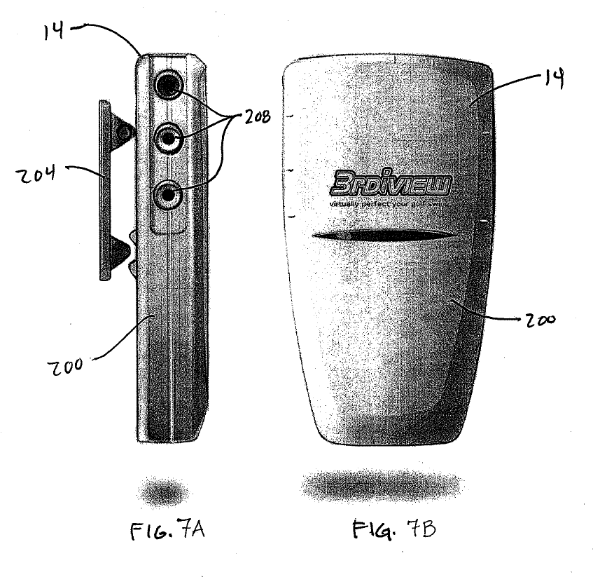

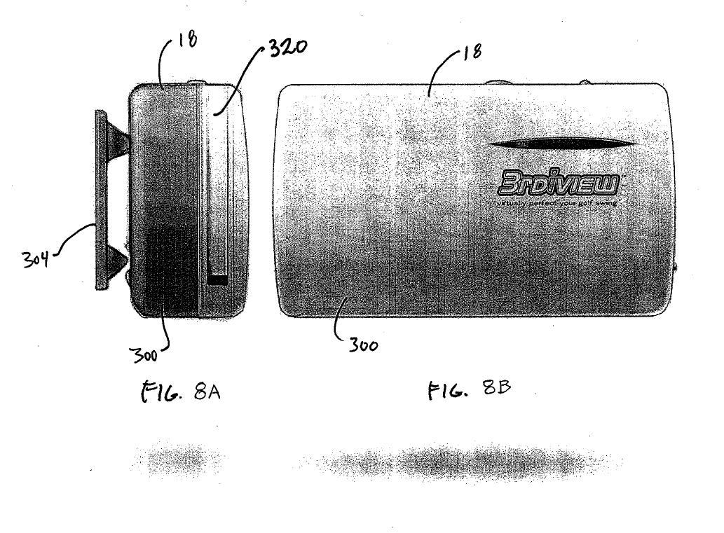

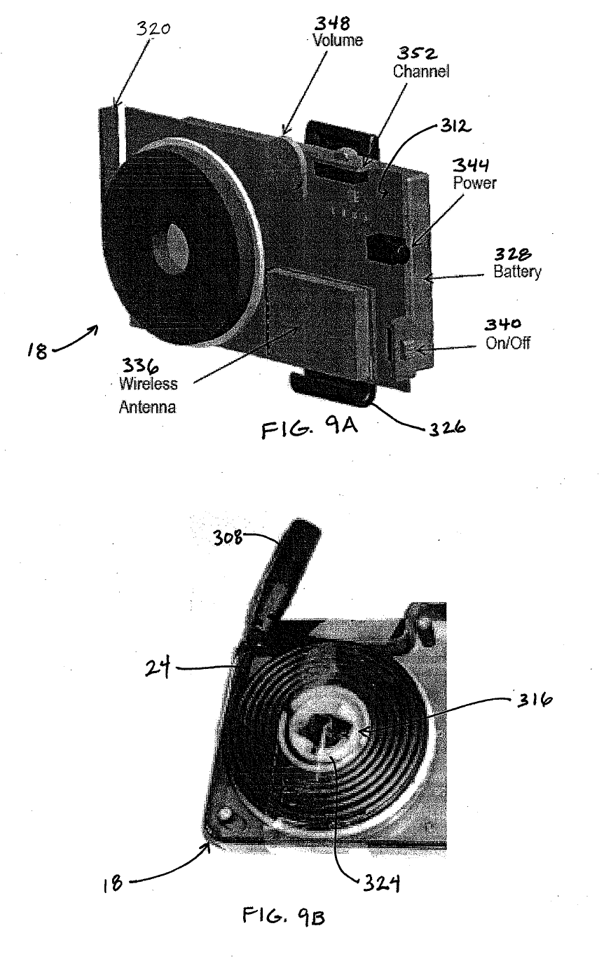

Referring now to FIGS. 3A-3E and 4A-4B, various partially disassembled and enlarged views are shown of various portions of the device 10 to illustrate various details of this embodiment of device 10. Device 10 comprises an input cable 100 entering the device through an arm 54. In put cable includes a connector (plug) 104 on an outer end of the input cable. Connector (plug) 104 is configured to removably connect to a corresponding connector (plug) (not shown) on device cable 24. For example, connector (plug) 104 can be a male connector (plug) to correspond to a female connector (plug) on device cable 24, or vice versa, and the two can be configured to snap fit together such that one or other includes structure that must be depressed and/or squeezed in order to disconnect them. In some embodiments, input cable 100 is integral to device cable 24 such that connector (plug) 104 can be omitted. An inner end 108 of input cable 100 is coupled to video display 34 (e.g., by way of a video engine that may include a processor, graphics card, and/or the like).

Device 10 further comprises audio cables 112 coupled to the input cable (e.g., by way of a video engine) such that the audio component of any input (e.g., video images or the like) can be routed to earphone jacks 116 in the arms, e.g., at a position near the user's ears when the device is worn, such that earbud or other earphones (not shown) can be plugged into the earphone jacks to deliver any audio sounds included in the video data to the user's ears. In other embodiments, the earbud or other earphones can be hardwired to the device such that the earphone jacks can be omitted, the device can comprise a single earphone jack, the earphones and jacks can be omitted entirely, and/or the device can instead comprise speakers.

Frame 38 comprises a central housing member 118, a video screen support 120, and one or more lateral housing members 124. Video screen support 120 is configured to support video screens 34 and a video engine 128. Video engine 128 can comprise any suitable hardware for receiving and/or routing video data from the input cable to the video screens, such as, for example, a processor, memory, a graphics card, and/or the like. Video engine 128 can also be configured to receive, extract, and/or route an audio component of the video data or other input from the input cable to the earphone jacks 116 via audio cables 112. Central housing member 118 and/or lateral housing members 124 can be coupled to the frame and/or to one another by any suitable means, such as, for example, screws 132, pins 136, adhesive, clips, rivets, and/or the like. As with the pivotal coupling between frame 38 and lateral member 26, pins 136 permit central housing member 118 (and screen or screens 34) to pivot relative to frame 38 such that when frame 38 is rotated to a position shown in either of FIGS. 5A-6B, central housing member 118 can be pivoted relative to frame 38, such as, for example, to improve the line-of-sight from a user's eyes to the screens (e.g., visibility of the screen or screens to the user). In some embodiments, the video engine may include the video screens, or be characterized as including the video screens.

In the embodiment shown, each arm 54 comprises a central arm member 142, an outer arm housing 144, and an inner arm housing 146. Central arm members 142 are integral to lateral member 26. Each outer arm housing 144 and corresponding inner arm housing 146 are coupled to the corresponding central arm member 142 and/or to the lateral member by way of screws 148 or the like. Each outer arm housing 144 (and/or inner arm housing 146) can comprise one or more tabs or knobs 152 or the like to organize or configure input cable 100 and/or audio cables 112 between outer arm housings 144 and/or corresponding central arm members 142 and/or inner arm housings 146, as shown. In other embodiments, outer arm housings 144 and/or inner arm housings 146 can be omitted or integral to central arm members 142 and/or lateral member 26 such that arms 54 are hollow and/or otherwise provide a path for input cable 100 and/or audio cables 112; or, input cable 100 and/or audio cables 112 can be external to the arms.

In the embodiment shown, support member 42 is removably coupled to lateral member 26 by way of a tab 152 on support member 42 and a corresponding slot 156 in lateral member 26. Further, tab 152 is provided with a clip or protrusion 160 to resist removal of tab 152 from slot 156. However, clip 160 is flexible such that tab 152 can be removed from slot 156 by applying a sufficient force and/or depressing clip 160.

In the embodiment shown, ends 28 and 30 of lateral member 26 include circular cylindrical receiving portions 164 that are configured to at least partially receive bushings or bearings 168. Bushings 168 are configured to permit tension screws 50 to extend through bushings 168 into lateral member 26 (and/or central arm members 142) and to improve rotation of frame 38 relative to lateral member 26 and/or arms 54. In some embodiments, bushings 168 are configured instead to include interior threads corresponding to the threads of tension screws 50 such that bushings 168 can be glued and/or otherwise secured to lateral member 26 and/or arms 54 (e.g., through a press-fit).

In the embodiment shown, the device does not comprise its own power source (e.g., battery). Instead, the device is powered by the receiver, via the display cable. In other embodiments, the device can comprise a power source (not shown), such as, for example, one or more batteries.

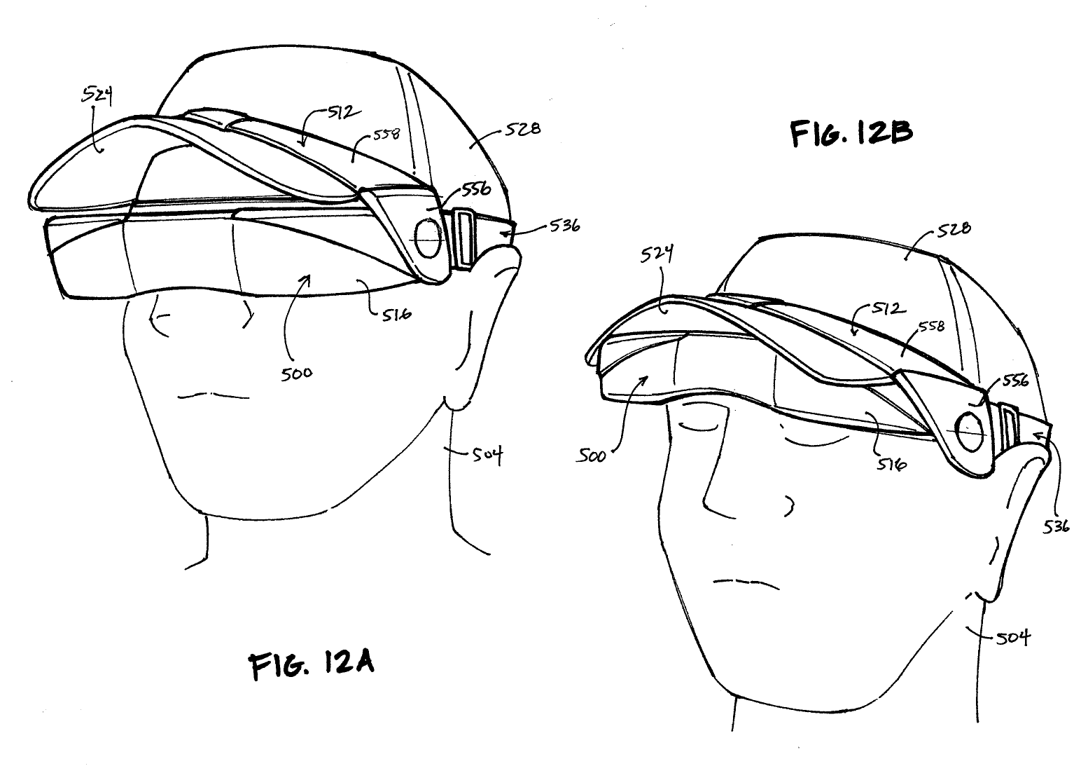

Referring now to FIGS. 7A-7B, side and front views, respectively are shown of an emitter 14 that is suitable for use with the system 5. Emitter 14 is configured to be capable of wirelessly transmitting video data including, but not necessarily limited to, video images. For example, in some embodiments, the emitter is configured to be capable of wirelessly transmitting video data including only video images; and in other embodiments, the emitter is configured to be capable of wirelessly transmitting video data including video images and/or audio sounds (e.g., an audio component). The emitter comprises a housing 200, a belt clip 204, one or more input jacks 208, and a transmitter module (see, e.g., FIG. 10). The input jacks are configured to permit a video source to be connected to the emitter such that the emitter can access or receive video data from the video source and transmit the video data wirelessly to the receiver. The emitter can also comprise a charging jack (not shown, but individually known in the art) and one or more output jacks (not shown, but individually known in the art). The charging jack is configured to permit a power source, e.g., a wall plug (not shown, but individually known in the art) or the like, to be connected to the emitter and charge an internal battery (in embodiments where the emitter is provided with a rechargeable battery). The emitter can also comprise a charging indicator light (not shown, but individually known in the art) configured, if a wall plug is connected to the emitter and a wall outlet, to emit red light when the battery is charging, and to emit green light when the battery is fully charged. The emitter can also comprise an internal charging circuit or the like (not shown, but individually known in the art) to control the rate of charge. The one or more output jacks can be configured to output video data to a local display, or to output audio sounds included in the video data to a local speaker, earphones, or the like.

FIG. 10 depicts a schematic of one example of a suitable transmitter module that is available from Airwave Technologies, Inc., Hsinchu, Taiwan, and that has a product designation of AWM651 TX 2.4 GHz Wideband FM Transmitter Module.

The emitter can also be configured to transmit wirelessly video data at a two or more frequencies or channels, e.g., 2414 MHz, 2432 MHz, 2450 MHz, and 2468 MHz. In such embodiments, the emitter can comprise a channel switch (not shown, but individually known in the art) and two or more channel lights (not shown, but individually known in the art). The channel switch is configured to permit a user to switch between the two or more channels, and the two or more channel lights are each configured to emit light when a corresponding channel is selected. In some embodiments, the emitter can also comprise an on/off switch; or can be configured to automatically turn on if a video source is connected, and automatically turn off if a video source is disconnected.

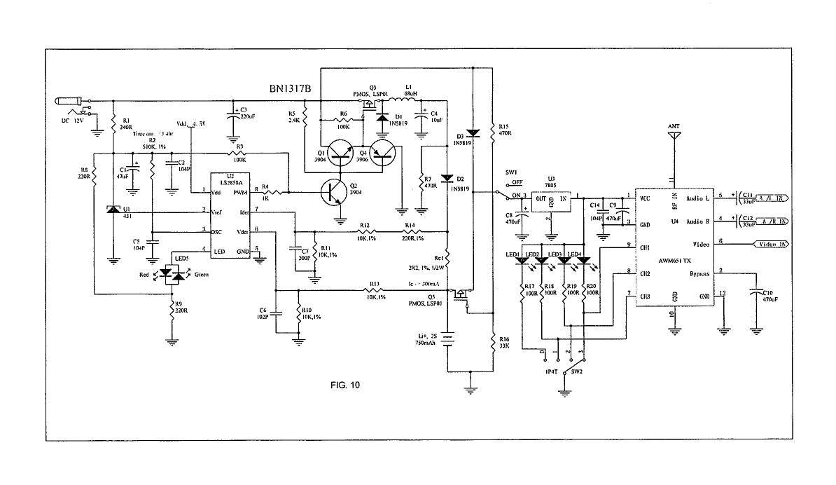

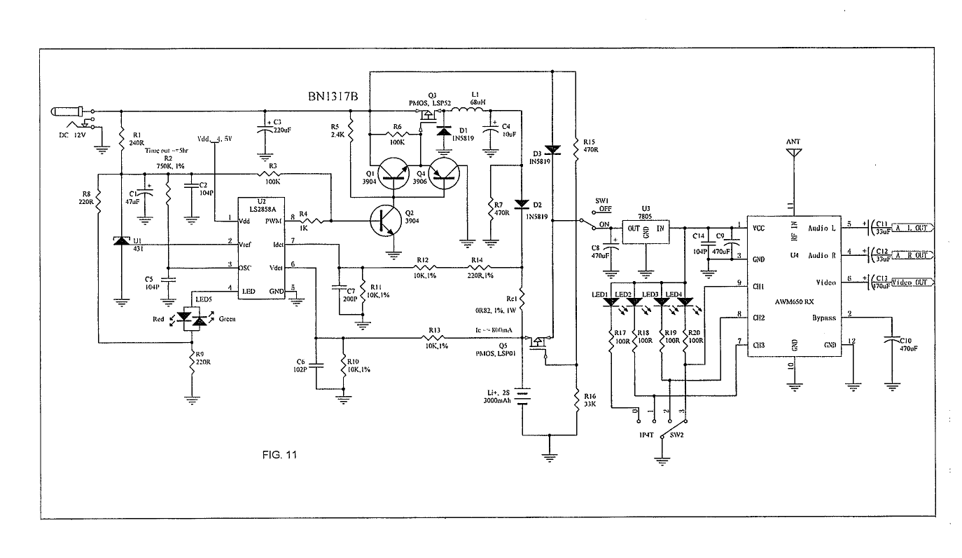

Referring now to FIGS. 8A-8B and 9A-9B, various views are shown of a receiver 18 that is suitable for use with the system 5. Receiver 18 is configured to be capable, if video data is wirelessly transmitted from the emitter, of receiving wirelessly the video data from the emitter and communicating the video data to display 10. The receiver comprises a housing 300, a belt clip 304, display cable 24, a connector (plug) 308, and a receiver module 312. Connector 304 is configured to be coupled to the connector of the user-wearable video display device such that video data can be communicated from the receiver to the to the user-wearable video display device via display cable 24 and input cable 100 such that the receiver can communicate video data to the device if such video data is received wirelessly from an emitter.

FIG. 11 depicts a schematic of one example of a suitable receiver module that may be used for module 312 and that is available from Airwave Technologies, Inc., Hsinchu, Taiwan, and that has a product designation of AWM650RX 2.4 GHz Wideband FM Receiver Module.

In the embodiment shown, the receiver comprises a cable retractor 316 having an actuator 320 and configured to retract display cable 24 responsive to the actuator being actuated by a user. More specifically, cable retractor 316 comprises a spool 324 that is spring-loaded such that as the display cable is pulled out of the receiver (and unwound from the spool), the spring is increasingly coiled such that actuating the actuator releases the spring and permits the spring to re-coil the display cable around the spool. In other embodiments, the cable retractor can be omitted. The receiver can also comprise a clip 326 configured to removable receive connector 308 (e.g., when display cable 24 is retracted).

In the embodiment shown, the receiver comprises a rechargeable battery 328. The receiver can also comprise a charging jack. The charging jack is configured to permit a power source, e.g., a wall plug or the like, to be connected to the receiver and charge an internal battery. The receiver can also comprise a charging indicator light configured, if a wall plug is connected to the receiver and a wall outlet, to emit red light when the battery is charging, and to emit green light when the battery is fully charged. The receiver can also comprise an internal charging circuit or the like to control the rate of charge. In other embodiments, the battery can be a non-rechargeable battery, or can be omitted in favor of an external power source.

Receiver module 312 comprises a printed circuit board 332 having a wireless antenna 336, an on/off switch 340, a power indicator light 344, and a volume control 348 for controlling the volume level of an audio component of video data transmitted to the device (if such an audio component is present in the video data). In some embodiments, the on/off switch can be omitted and/or the receiver can be configured to automatically turn on if a device is connected, and automatically turn off if a device is disconnected. In some embodiments, the antenna may be integrated into the electrical components coupled directly to the frame (e.g., the antenna may be part of a video engine).

The receiver can also be configured to receive wirelessly video data at a two or more frequencies or channels, e.g., 2414 MHz, 2432 MHz, 2450 MHz, and 2468 MHz, that correspond to at least one channel of an emitter. In such embodiments, the receiver can comprise a channel switch 352 and/or two or more channel lights. Channel switch 352 is configured to permit a user to switch between the two or more channels, and the two or more channel lights are each configured to emit light when a corresponding channel is selected. In this way, a plurality of emitters can be used with a single receiver. For example, a first video source (camera having a first view) can be connected to a first emitter that is set to a first channel; and a second video source (e.g., camera having a second view) can be connected to a second emitter that is set to a second channel; such that a user with a receiver connected to a user-wearable video display device can use the channel switch 328 on the receiver to switch between viewing the first view and the second view. These same principles can be applied to configure emitters and receivers that permit a user to switch between any number of views or video sources, such as, for example, two, three, four, or the like.

The various parts and elements of device 10, emitter 14, and receiver 18 can comprise any suitable materials. For example, the frame, arms, and arm bases of the device; and/or the housing and belt clip of the emitter and receiver, can comprise plastic, polymer, carbon fiber, or the like. Similarly, various parts or components can be formed or manufactured or formed by any suitable methods, such as, for example, injection molding, or the like. Although not described in detail, it will be understood by those of skill in the art that various wiring, circuitry, and the like may be required for device 10 to be capable of functioning as described. For example, the video engine of the device may include a video processor, graphics card, or the like.

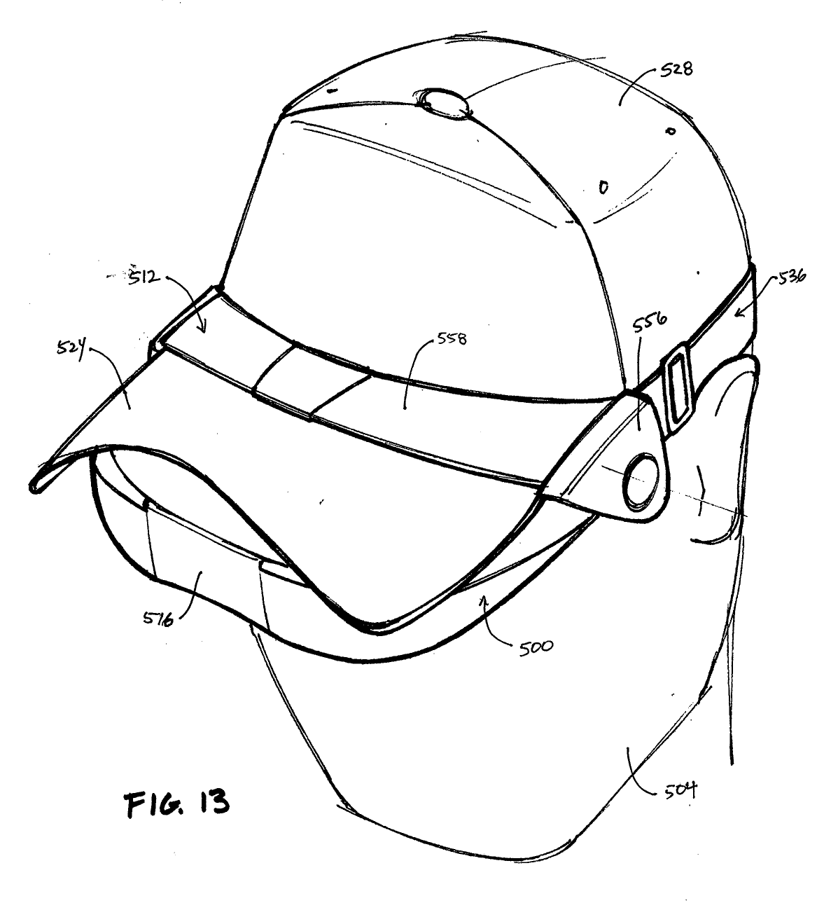

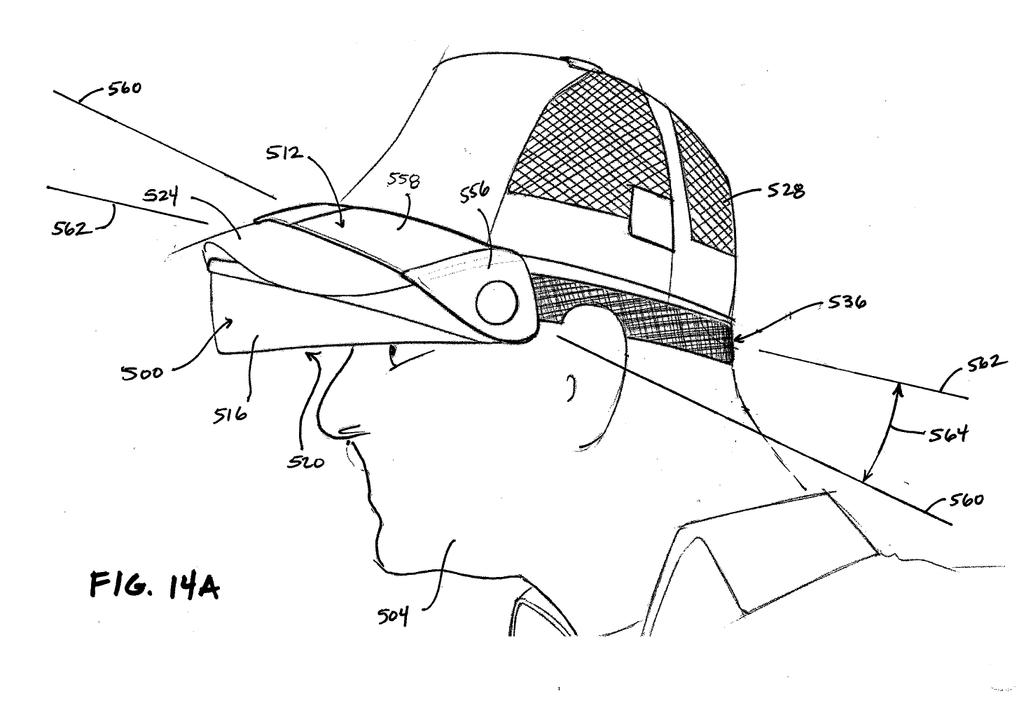

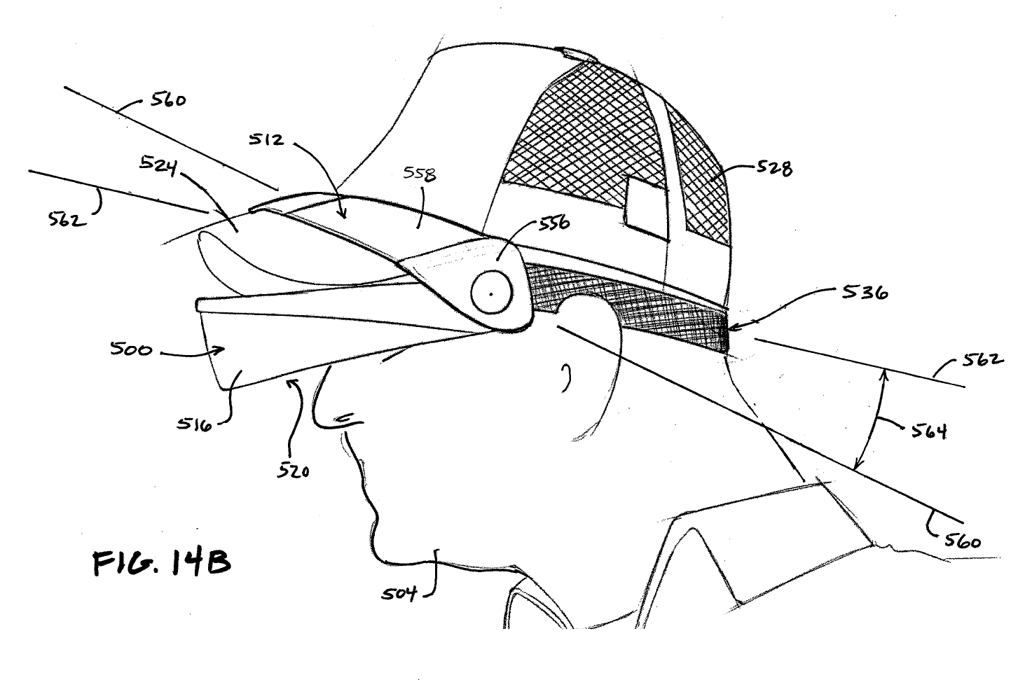

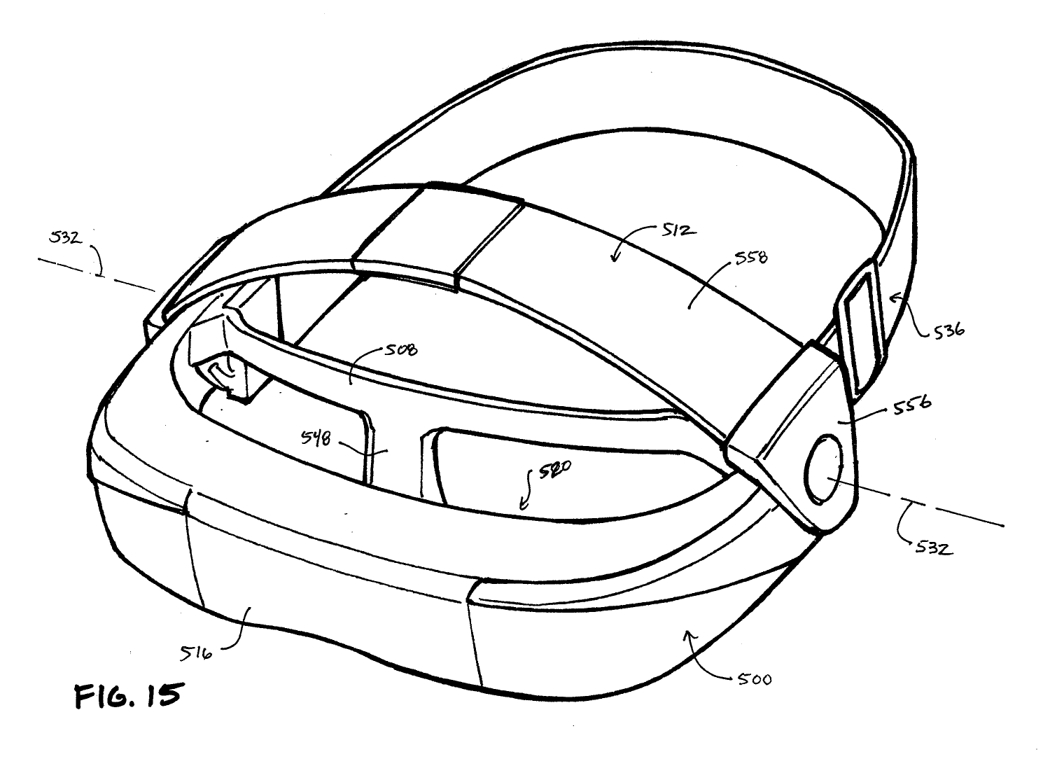

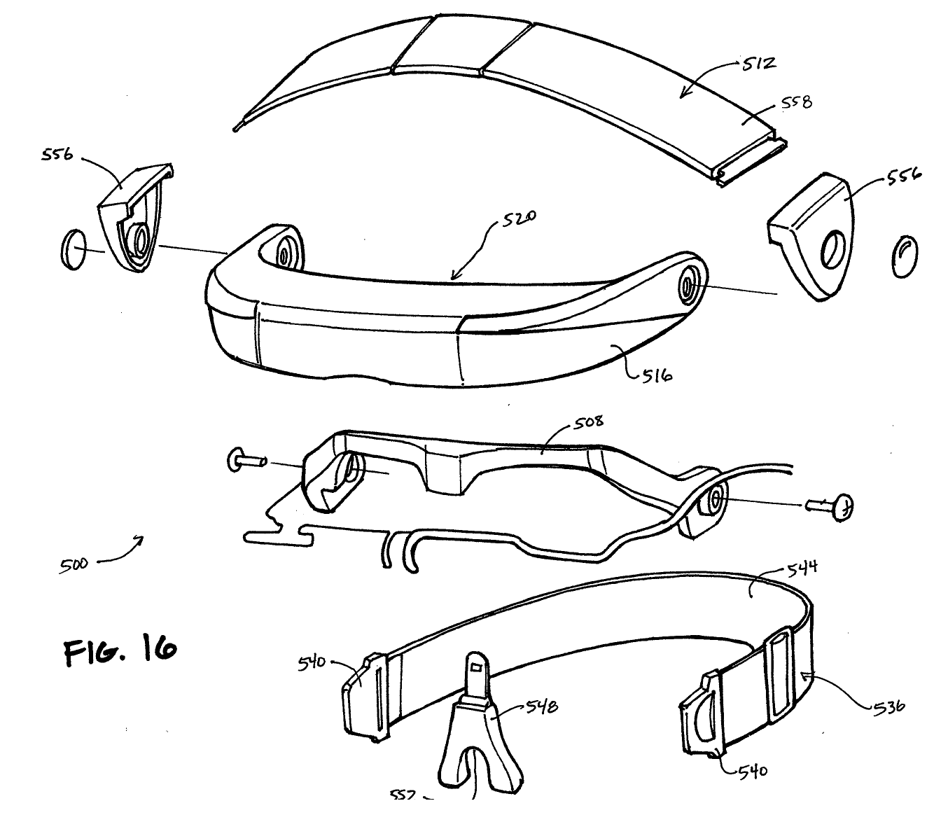

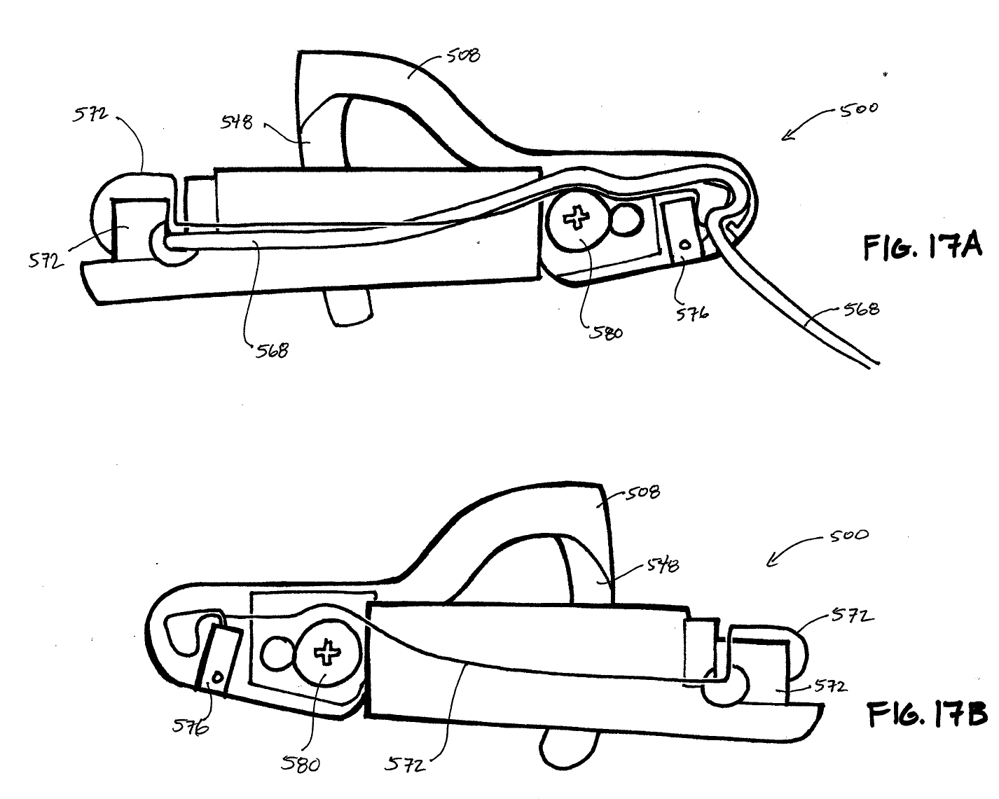

Referring now to FIGS. 12A-12B, 13, 14A-14B, 15, and 16, various views of another embodiment of a user-wearable video-display device 500 are shown. FIGS. 12A and 12B depict perspective views of device 500 worn by user 504; FIG. 13 depicts an upper perspective view of device 500 worn by a user 504; FIGS. 14A and 14B depict side views of device 500 worn by a user 504; FIG. 15 depicts a perspective view of device 500 alone; and FIG. 16 depicts an exploded view of device 500 alone. Device 500 is similar in some respects to device 10, and the differences are primarily described here. Device 500 is suitable for use with the system of FIG. 1.

In the embodiment shown, device 500 comprises: a lateral member 508; a frame 512 pivotally coupled to lateral member 508; a hat bill-attachment structure 512 coupled to frame 516; and a video screen 520 coupled to frame 516 and capable of displaying video images. In the embodiment shown, device 500 is configured to be wearable by a user 504 such that, if the device is worn by a user 504, the video screen 520 is in front of the user's face, and lateral member 508 extends across a portion of the user's face, as shown. As described in more detail below, in the embodiment shown, hat bill-attachment structure 512 is configured to be removably (or permanently) coupled to the bill 524 of a hat 528 (e.g., to rest on the bill of a hat) such that device 500 can be worn by a user 504 with video screen 520 in front of the user's face.

Device 500 (e.g., lateral member 508, frame 516, and/or video screen 520) can be configured in any of the ways described above with reference to device 10. For example, as described above for device 10, device 500 is configured such that the frame is capable of pivoting relative to the lateral member about a lateral horizontal axis 532 extending through the lateral member. By way of another example, video screen 520 can comprise two video screens coupled to the frame, each of which is capable of displaying video images. By way of another example, although device 500 is shown without arms, and can be described as a user-wearable video-display device that has no arms, some embodiments of device 500 can comprise arms, configured, for example, in any of the ways described above with reference to device 10. Similarly, embodiments of the present systems, kits, and methods can comprise various embodiments of device 500.

In the embodiment shown, device 500 further comprises a user-attachment band structure 536 coupled to the lateral member. User-attachment band structure can also be configured in any of the ways described above with reference to device 10. For example, in the embodiment shown, user-attachment band structure comprises first and second band clips 540; and an elongated band 544 coupled to and extending between first and second band clips 540; where the first band clip is configured to be capable of being coupled to the left side of the lateral member, and the second band clip is configured to be capable of being coupled to the right side of the lateral member.

In the embodiment shown, device 500 further comprises a support member 548 coupled to lateral member 508, the support member having a bridge end 552; and device 500 is further configured to be wearable by a user 504 such that, if the device is worn by a user 504, bridge end 552 of the support member rests on the user's nose. Support member 548 can be also be configured in any of the ways described above with reference to device 10. For example, support member 548 can be removably coupled to the lateral member, or support member 548 can be integral to the lateral member.

As mentioned above, in the embodiment shown, hat bill-attachment structure 512 is configured to be removably (or permanently) coupled to the bill 524 of a hat 528 such that device 500 can be worn by a user 504 with video screen 520 in front of the user's face. More specifically, in the embodiment shown, hat bill-attachment structure 512 comprises: two hubs 556 coupled to lateral member 508 (e.g., by way of tension screws 580, described below); and a lateral portion 558 extending between hubs 556. In some embodiments, lateral portion 558 is configured to match the contour of the hat bill 524. For example, in the embodiment shown, lateral portion 558 comprises an elastic band. In other embodiments, lateral portion 558 can comprise a substantially rigid material such as plastic, aluminum, carbon fiber, or the like. In some embodiments, the hat bill-attachment structure includes an elastic band.

In the embodiment shown, hat bill-attachment structure 512 is oriented in a first plane 560, user-attachment band structure 536 is oriented in a second plane 562, and the first and second planes 560 and 562, respectively, are oriented at an angle 564 of between 5 and 45 degrees to each other. In other embodiments, the first and second planes are oriented at an angle 564 of between 10 and 30 degrees to each other, between 15 and 25 degrees to each other, or at any other degree between 0 and 90 degrees.

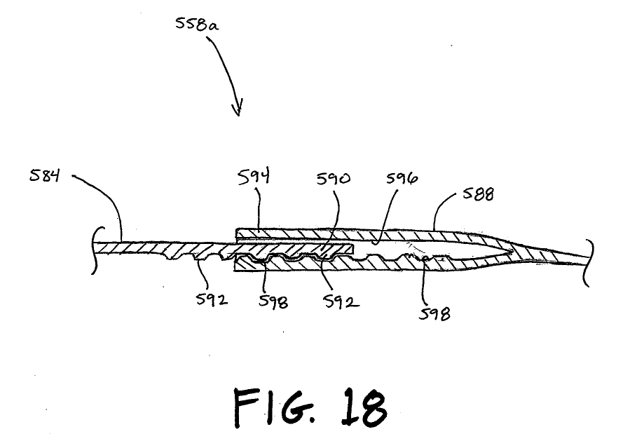

Referring now to FIGS. 17A and 17B, partially disassembled side views are shown of device 500 alone (not worn by a user such as user 504). As described above for device 10, device 500 comprises an input cable 568 entering the device through the lateral member and connected to a video engine 572. Device 500 further comprises audio cables 576 coupled to the input cable (e.g., by way of a video engine) such that the audio component of any input (e.g., video images or the like) can be routed to earphone jacks 576 in a rearward portion of the lateral member, e.g., at a position near the user's ears when the device is worn, such that earbud or other earphones (not shown) can be plugged into the earphone jacks to deliver any audio sounds included in the video data to the user's ears. In other embodiments, the earbud or other earphones can be hardwired to the device such that the earphone jacks can be omitted, the device can comprise a single earphone jack, the earphones and jacks can be omitted entirely, and/or the device can instead comprise speakers.

As also described above with reference to device 10, the embodiment of device 500 shown is configured such that the frame is pivotally coupled to the lateral member such that at least one characteristic of the pivotal relationship between the frame and lateral member is adjustable. More specifically, the frame is pivotally coupled to the lateral member by tension screws 580 such that the force required to pivot the frame relative to the lateral member can be adjusted by rotating one or more of tension screws 580.

FIG. 18 depicts an enlarged, cross-sectional view of one embodiment of an adjustable lateral portion 558a suitable for use or inclusion in some embodiments of hat bill-attachment structure 512. Lateral portion 558a comprises a first piece 584 configured to be coupled to one of hubs 556, and a second piece 588 configured to be coupled to the other of hubs 556. First piece 584 has a coupling end 590 including at least one protrusion 592 (though it may, as shown, include a plurality of protrusions 592). Second piece 588 has a coupling end 594 including an opening 596 and a plurality of indents 598 configured to correspond to protrusions 592, as shown. In this embodiment, coupling end 590 is a “male” connector configured to be inserted into the “female” connector coupling end 594 (e.g., opening 596), as shown, such that the position of first piece 584 can be adjusted relative to second piece 588 to adjust the overall length of lateral portion 558a. In some embodiments, lateral portion 558a can comprise a substantially rigid material such as plastic, aluminum, carbon fiber, or the like.

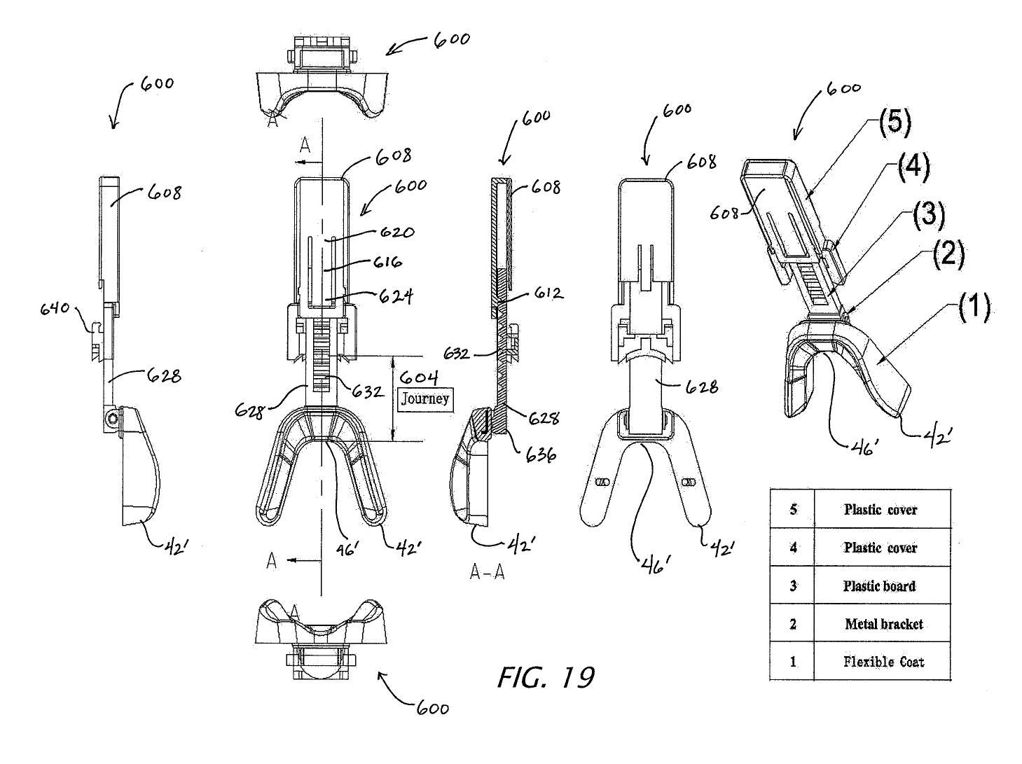

Referring now to FIG. 19, various views are shown of an adjustment assembly 600 for use with some embodiments of the present user-wearable video display devices. In particular, adjustment assembly 600 comprises a support member 42′ similar to support member 42 described above (e.g., support member 42′ has a bridge end 46′ configured to be capable of resting on the bridge of a user's nose when the display is worn by a user). Adjustment assembly 600 can be coupled to some embodiments of the present user-wearable display devices to configure the devices to be wearable by a user such that, if the device is worn by a user, the video screen is in front of the user's face and the bridge end of the support member rests on the user's nose. In the embodiment shown, adjustment assembly 600 can be coupled to the lateral member (e.g., 26) such that support member 42′ is adjustably coupled to the lateral member, and such that bridge end 46′ of the support member can be extended a distance 604 downward from the lateral member, where distance 604 is adjustable by at least 0.5 inches (a range of at least 0.5 inches). In some embodiments, the distance 50 is adjustable by at least, more than, equal to, less than, or any range between, any of: 0.1 inches, 0.2 inches, 0.3 inches, 0.4 inches, 0.5 inches, 0.6 inches, 0.7 inches, 0.8 inches, 0.9 inches, 1.0 inches, 1.1 inches, 1.2 inches, 1.3 inches, 1.4 inches, 1.5 inches, 1.6 inches, 1.7 inches, 1.8 inches, 1.9 inches, and 2.0 inches.

In the embodiment shown, adjustment assembly comprises an adjustment member 608 coupled to the frame and the support member. As shown, adjustment member 608 comprises a protrusion 612. More specifically, in the depicted embodiment the adjustment member comprises a tab 616 having a first end 620 connected to the adjustment member, and a second end 624 capable of moving relative to the adjustment member, and protrusion 612 is disposed on second end 624 of the tab. Support member 42′ has an elongated portion 628 slidably coupled to the adjustment member 608 such that protrusion 612 is capable of contacting elongated portion 628 to resist movement of elongated portion 628 relative to adjustment member 608. Elongated portion 628 can also have at least one indent 632 configured to be capable of receiving at least a portion of protrusion 612. Elongated portion 628 can have a length of at least 0.5 inches, e.g., in embodiments in which distance 604 is adjustable by at least 0.5 inches. Similarly, elongated portion 628 can have a length of at least, more than, less than, or any range between, any of: 0.1 inches, 0.2 inches, 0.3 inches, 0.4 inches, 0.5 inches, 0.6 inches, 0.7 inches, 0.8 inches, 0.9 inches, 1.0 inches, 1.1 inches, 1.2 inches, 1.3 inches, 1.4 inches, 1.5 inches, 1.6 inches, 1.7 inches, 1.8 inches, 1.9 inches, and 2.0 inches. In some embodiments, at least one indent 632 can be disposed at least 0.5 inches (or any other suitable distance, such as those listed in this paragraph) from a lower end 636 of elongated portion 628. In some embodiments, the elongated portion can have a plurality of indents 632 disposed sequentially, as shown, along at least a portion of the length of the elongated portion. As a result of configuring any of the present devices (e.g., 10) in this manner, the device (and, more specifically support member 42′) can have a non-extended position in which support member 42′ is as close to the lateral member as possible, and any one of multiple extended positions that allow a wearer of the device, who desires to use it as a training aide to view real-time video images of a sports movement (or the like) the wearer performs, to adjust the height of the lateral portion to best suit the sports movement the wearer wishes to perform. As described in greater detail below, embodiments of the device are also configured such that the frame can be pivoted or rotated such that, when the device (or, more specifically, the support member of the device) is in an extended position (so that the lateral member has been raised to a degree off of the wearer's nose), the angle of the video screen can be adjusted to be viewed (or more easily viewed) by the wearer. These two features—extendability of support member 42′ and pivotability of the frame relative to the lateral member—can be combined to best suit a given use of embodiments of the devices.

In the depicted embodiment, tab 616 is integrally formed with the adjustment member such that the second end of the tab resists lateral movement relative to the first end of the tab. In this way, the tab provides some spring-type resistance to removal of the protrusion from an indent 632 so as to resist linear movement of the elongated portion of the support member relative to the adjustment member. In other embodiments, the tab can be a separate piece that is coupled to the adjustment member for similar effect. In some embodiments, the tab can comprise two or more protrusions; or the tab can be omitted entirely and the protrusion disposed on another portion of the adjustment member. The adjustment member can be coupled to the lateral member by any suitable means. For example, the adjustment member can comprise a clip 640, and the lateral portion can comprise a corresponding receiver (e.g., slot 156) for mechanically receiving or engaging the clip 640 of the adjustment member. In other embodiments, the adjustment member can be coupled to the lateral member by any suitable means, including, for example, adhesive, screws, pins, rivets, or the like. In this way, adjustment member 608 can be coupled to the lateral member and support member 42′ such that, for example, the adjustment member is substantially fixed relative to the frame, and the support member is slidable relative to, or slidably coupled to, the adjustment member. As used here, “slidable” and “slidably” include linear, ratchet-type interaction of protrusion 612 and plurality of indents 632.

In some embodiments of the present methods, the video source is a video camera, and the methods include (1) positioning or configuring the video camera to be capable of capturing video data including video images of the user performing an activity (or multiple cameras positioned or configured to capture video images of the user from different angles); (2) performing an activity; (3) capturing video data (e.g., capturing live video data to enable a live video data transmission) including video images of the user performing an activity; (4) transmitting wirelessly the video data to the receiver (e.g., over a distance up to, using the version of the emitter and transceiver described above, 100 yards); (5) transmitting or otherwise communicating the video data from the receiver to the display; and (6) displaying the video images included in the video data (e.g., while the activity is ongoing in some embodiments, and after the activity is complete in other embodiments).

The activity can comprise any one or more of performing a sports movement or technique (e.g., karate; swinging a piece of sports equipment (e.g., a golf club, a bat, a racket (e.g., tennis or squash), a hockey stick, or the like); throwing a ball (e.g., a football, a baseball, a softball, a basketball, or the like)); performing a medical procedure (e.g., surgery, suture, incision, and the like), or any other activity in which a video image of the activity may assist the user in improving or understanding the activity or the manner in which the activity is performed. In some embodiments, a wearer can practice a sports movement (e.g., swinging a golf club, throwing a pitch, shooting a free-throw, throwing a football, or the like) and use an embodiment of the present devices to view real-time video images of that movement as the wearer performs it. In this way, the wearer may be able to make adjustments to the movement, and view the result of those adjustments, more quickly than has been possible with previous training aides. In other embodiments, the video source capturing the sports movement (or the like) may be configured with data storage and playback capability such that a wearer can view stored video data of a previously-performed sports movement using embodiments of the present devices.

Some embodiments of the present methods include capturing video data of a certain type of sports movement—as it is repeated or while a user wearing the device is in a given position in a single movement—from several different angles, such as (for example) capturing video data a user addressing a golf ball before he swings the golf club, which allows the user to view, for example: his alignment with respect to the target (when the camera is positioned “behind” the user along the intended path of the shot); the position of his left arm (or the position of his hands, shoulders, etc.) at address (when the camera is positioned “in front of” the user perpendicular to the intended path of the shot); and any other aspect of his setup or swing from any angle.

In other embodiments of the present methods, the video source is a video camera, and the methods include (1) positioning or configuring the video camera to be capable of capturing video data including video images of an object, a location, or the performance of an activity (or multiple cameras positioned or configured to capture video images of objects in different locations, of different locations, or of the performance of the activity from different angles); (2) capturing video data, including video data, of the object(s)/position/performance; (3) transmitting wirelessly the video data to the receiver (e.g., over a distance up to, using the version of the emitter and transceiver described above, 100 yards); (4) transmitting or otherwise communicating the video data from the receiver to the display; (5) in situations in which multiple cameras are used, toggling between video data sources to display video data from different cameras; and (6) displaying the video images included in the video data. The object(s) may be anything, including objects of interest in military or training exercises, objects of interest in hunts (e.g., wild game), objects in a race (e.g., cars on a track, runners on a track), or the like. In one embodiment, viewers/spectators of a race may rent the present devices, wear them during the race, and either actively toggle between different video sources during the race (e.g., to enable them to watch a given vehicle from several vantage points as it rounds a track) or passively view the data from toggled video sources. Similarly, the location may be any location, including locations of interest in military or training exercises, locations of interest in hunts (e.g., paths along which wild game travel), the location behind a vehicle (such as behind a car used in auto racing, or a delivery vehicle), the location (or locations) of interest to security guards (such as a location around a corner or in a room that is the guard has not yet entered, thus allowing the guard to verify that an area is clear before entering it), or the like. Similarly, the performance may be the performance of any activity, such as the performance of a medical procedure, such as an arthroscopic procedure (or an endoscopic procedure, more generally) in which the display is used to view real-time images from an arthroscopic camera, e.g., at a magnified resolution. One example in which multiple video sources may be used involves a quarterback wearing one of the present devices in a practice environment in which at least one camera is positioned to capture video images of him while another is positioned to capture video images of an area downfield from him, so that he can be shown live video data (taken from above the field, for example) of the manner in which the defense reacts to the offense as well, before/after toggling between video data inputs, as live video data of his movement(s).

In some embodiments of the present methods, a camera is positioned to capture images of a child (e.g., the user's child) and the images are transmitted to the receiver and communicated to the display, such that, for example, the user can view or monitor their child (e.g., a child in a crib and/or a child with special needs that requires ocular monitoring) even while the user is engaged in other activities (e.g., gardening, mowing, etc.). In other embodiments of the present methods, video data is transmitted from a computer or the like such that the display can display video data for the computer (e.g., video data that would otherwise be transmitted to and/or displayed on a monitor) such that, for example, the user can view the video data from the computer without disturbing or exposing the contents of the data to others around the user (e.g., on a plane, train, or the like).

The various illustrative embodiments of devices, systems, and methods described herein are not intended to be limited to the particular forms disclosed. Rather, they include all modifications, equivalents, and alternatives falling within the scope of the claims. For example, in some embodiments, such as those depicted above that include arms, the arms could be omitted and the display could be integral to a hat, helmet, or the like. As another example, any stereoscopic video display system may be used with the present devices, whether that includes one or more than one video screen. As yet another example, while the embodiments depicted above that include a hat bill-attachment structure are shown with an elastic band, the present hat bill-attachment structures can take any other suitable form, including, for example, a pair of clips that attach (e.g., by clamping down on) opposing sides of a hat bill. Furthermore, the depicted elastic band may include an slide-resistant element, such as one or more sections that include hook and loop fasteners that would couple to the top of the hat bill and tend to prevent the band from sliding out of position.

The claims are not intended to include, and should not be interpreted to include, means-plus- or step-plus-function limitations, unless such a limitation is explicitly recited in a given claim using the phrase(s) “means for” or “step for,” respectively.

What is claimed is:

1. A user-wearable video display device, comprising:
a lateral member;
a frame pivotally coupled to the lateral member; and
a video screen coupled to the frame and capable of displaying video images;
where the device is configured to be wearable by a user such that, if the device is worn by a user, the video screen is in front of the user's face, and the lateral member extends across a portion of the user's face.

2. The user-wearable video display device of claim 1, where the video screen coupled to the frame and capable of displaying video images comprises two video screens coupled to the frame, each of which is capable of displaying video images.

3. The user-wearable video display device of claim 1, where the video screen is coupled to the frame through a housing member that is pivotally coupled to the frame and that can pivot relative to the frame.

4. The user-wearable video display device of claim 1, where the device is further configured to be wearable by a user such that, if the device is worn by a user, the lateral member contacts a portion of the user's face.

5. The user-wearable video display device of claim 1, where the lateral member comprises a non-rigid material.

6.-7. (canceled)

8. The user-wearable video display device of claim 1, where the device is configured such that the frame is capable of pivoting relative to the lateral member about a lateral horizontal axis extending through the lateral member.

9. The user-wearable video display device of claim 1, further comprising:
two arms coupled to the lateral member such that the frame is capable of pivoting relative to the lateral member and both arms about a lateral horizontal axis extending through at least one of the lateral member and both arms;
where the device is further configured to be wearable by a user such that, if the device is worn by a user, each of the two arms extends over a different one of the user's ears.

10. The user-wearable video display device of claim 9, where the two arms are integral to the lateral member.

11.-19. (canceled)

20. A user-wearable video display device, comprising:
a lateral member;
two arms coupled to the lateral member;
a frame pivotally coupled to the lateral member; and
a video screen coupled to the frame and capable of displaying video images;
where the device is configured to be wearable by a user such that, if the device is worn by a user, the video screen is in front of the user's face and each of the two arms extends over a different one of the user's ears.

21. The user-wearable video display device of claim 20, where the video screen coupled to the frame and capable of displaying video images comprises two video screens coupled to the frame, each of which is capable of displaying video images.

22. The user-wearable video display device of claim 20, where the video screen is coupled to the frame through a housing member that is pivotally coupled to the frame and that can pivot relative to the frame.

23.-64. (canceled)

65. A user-wearable video display device, comprising:
a lateral member;
a frame pivotally coupled to the lateral member; and
a hat bill-attachment structure coupled to the frame;
a video screen coupled to the frame and capable of displaying video images;
where the device is configured to be wearable by a user such that, if the device is worn by a user, the video screen is in front of the user's face, and the lateral member extends across a portion of the user's face.

66. The user-wearable video display device of claim 65, where the hat bill-attachment structure comprises an adjustable lateral portion configured to be coupled to the bill of a hat.

67. The user-wearable video display device of claim 65, where the video screen coupled to the frame and capable of displaying video images comprises two video screens coupled to the frame, each of which is capable of displaying video images.

68. The user-wearable video display device of claim 45, where the video screen is coupled to the frame through a housing member that is pivotally coupled to the frame and that can pivot relative to the frame.

69. The user-wearable video display device of claim 65, where the device is further configured to be wearable by a user such that, if the device is worn by a user, the lateral member contacts a portion of the user's face.

70.-81. (canceled)

82. The user-wearable video display device of claim 65, where the hat bill-attachment structure is oriented in a first plane, the user-attachment band structure is oriented in a second plane, and the first and second planes are oriented at an angle of between 0 and 45 degrees to each other.

83. The user-wearable video display device of claim 65, further comprising:
a support member coupled to the lateral member, the support member having a bridge end;
where device is further configured to be wearable by a user such that, if the device is worn by a user, the bridge end of the support member rests on the user's nose.

84.-89. (canceled)

90. The user-wearable video display device of claim 65, where the frame is pivotally coupled to the lateral member such that at least one characteristic of the pivotal relationship between the frame and lateral member is adjustable.

91. The user-wearable video display device of claim 90, where the frame is pivotally coupled to the lateral member by tension screws such that the force required to pivot the frame relative to the lateral member can be adjusted by rotating one or more of the tension screws.
